(19) United States
(12) Patent Application Publication
(10) Pub. No.: US 2021/0175701 A1
(43) Pub. Date: Jun. 10, 2021

(54) Total Shielding of electrical installations with automatic cutoff and restart

(71) Applicant: Jose Jairo Camargo, Samborondon (EC)

(72) Inventor: Jose Jairo Camargo, Samborondon (EC)

(21) Appl. No.: 17/076,840

(22) Filed: Oct. 22, 2020

(30) Foreign Application Priority Data
Dec. 6, 2019 (EC) 2019-87057

(51) Int. Cl. H02H 3/06; H02H 1/00; H02H 3/00

(52) U.S. Cl. CPC H02H 3/06; H02H 3/00; H02H 1/0007

(57) ABSTRACT

A system is provided to eliminate risks of electric damage in buildings from irregular, abnormal currents in electrical networks, devices, and ultimately the entire building, with automatic cutoff and restart of electrical fluid, restoring proper function once electric flow is normalized. It offers protection of building electrical installations against electrical surges through sensors, continuously monitoring input conditions. When harmful voltages or currents are detected, electric flow is cut off temporarily, and then restored when conditions go back to normal. Current design uses transient suppressors, contactors, a timer, and thermomagnetic switches (FIG. 1). This concept is targeted at residential, commercial, and industrial electrical installations. It solves the vulnerability to unexpected, external, devastating electrical surges. It can be used as stand-alone safety equipment, or integrated to conventional thermomagnetic breaker systems. Design can be modified depending on desired electric-security level and availability of current or new technology in electrical components.

### BACKGROUND

Until now, the state-of-the-art has been offering security in the event of an electrical accident, like a short circuit, that occurs only inside the served building, through the use of a thermomagnetic switch box, but does not offer any protection against sudden surges or changes in voltage from the external supply system. These sudden changes in voltage occur especially at the reconnection of service by the electric utility following a temporary suspension or after an unexpected cut in the flow of electricity from the external network and consequent recovery.

With the current technology, when electric service from the external network is interrupted for any reason, the user must immediately run to turn off the breakers to avoid the entrance of overvoltages at the restart of service. The user must then watch for the return of electric service to activate the breakers, typically in the darkness of the environment, running the risk of making such reconnection prior to or within the period of sudden, abrupt voltage variations with harmful impact to the installation equipment.

The technological sector to which the invention refers is the electrical sector of “Electric Techniques not otherwise provided for.” Its international classification is: H05.

### SUMMARY

This Total Shielding with automatic cutoff and restart of the electrical fluid offers high security in installations of any building.

The Total Shielding system contains a set of elements with different functions or behaviors in electric environments that, when properly articulated, offer total safety and protection from external power surges in the whole electrical installation of a residential, industrial, or commercial building. It also eliminates risks from the so-called electrical flashing, which is a behavior of low-magnitude voltage fluctuations, and from the so-called flicker that consists of rapid and repetitive voltage changes that could reach 90% of the design voltage. Furthermore, it offers protection from the harmful effects of high-voltage electrical discharges associated with atmospheric phenomena.

Total Shielding detects the abnormal voltages or currents before they enter the installation, then cuts off the electric flow and automatically resumes it after normal conditions have been reestablished. In this manner, it protects the entire electric installation and all devices that may be connected to it, and it automatically resumes electric service to all of the installation.

Unlike the current technology, which is based on the use of thermomagnetic breakers and offers protection only from events within the internal electric installation, the proposed Total Shielding system offers the following four types of protection to the entire electric installation, without the need for any human intervention:

1. It eliminates the effect of low or typically imperceptible voltage deviations that, although they do not damage the equipment, can reduce its useful life. This is accomplished by suspending the electric service to the installation while these voltage deviations are taking place, and restoring service once voltage goes back to its normal range.

2. It cuts off the electric flow temporarily in case of an undesired power surge, avoiding the damaging effects of the high voltage peaks and their fluctuations, and it automatically reconnects the electric fluid after service is normalized.

3. It continues to maintain the entire electrical installation insulated from any surges and their harmful effects that typically occur right after the electric utility reconnects service. Total Shielding keeps the electric installation disconnected from the external source even during the early stages of external service reconnection; only when voltages are stabilized at their normal levels, is electric service to the installation restored.

Total Shielding automatically disconnects the installation from the external network in case of any power outage or blackout and reconnects it only when conditions have returned to normal, all in a safe and effective manner without the need for any human interaction; it prevents electricity from flowing during the period when voltages are varying in an erratic fashion, right after the external power source re-establishes service.

4. It protects the electric installation from the disastrous effects of atmospheric phenomena, such as lightning strikes, or accidents in external networks involving falling trees or falling electric poles. These events can cause extremely high power surges in the external networks that, if allowed to enter a building installation, could cause extensive damage in electrical equipment, overheating or burning of electric wiring, and even a fire in the property, as it occasionally happens. Total Shielding provides protection in these eventual catastrophic overloads by detecting the upcoming surge and instantaneously having a contactor act as a general fuse; it allows its internal coil to burn out, thereby cutting off the flow of current to the electric installation. The present design calls for a minor maintenance operation in this situation, but no damage to the installation is suffered as a result of such an event that occurs quite rarely, but with potentially catastrophic effects.

A foreseeable effect of this invention could be a change in the manufacture of the so-called breaker boxes or thermomagnetic switches. A new box could be designed that incorporates to the traditional boxes, the circuits and functional elements of the Total Shielding system suggested herein, but with the final result of a single integrated box which would protect a building's electrical installation from potentially harmful voltages and currents. A second alternative is the design of a stand-alone Total Shielding box that would be installed in buildings by way of a protecting device, connected in series between the external power supply and the building's traditional electric box; it would also eliminate those harmful voltages and currents, and offer security to all internal equipment, including the integrity of the circuit breaker box. And a third alternative is the redesign of conventional breaker boxes incorporating only some of the features of Total Shielding. In all three alternatives, a building's entire electric installation is protected from undesired voltage and current surges.

### BRIEF DESCRIPTION OF THE DRAWING

FIG. 1 shows a Total Shielding design utilizing currently available technology that allows for all of the system performance requirements described above to be met. The following are the main components: a timer; a contactor with an internal coil; transient suppressors; a thermo-magnetic switch as a general breaker; an emergency switch to create a by-pass that allows the system to be maintained; bars for connecting thermomagnetic switches or breakers that supply power to each one of the internal circuits; the neutral bar; and the grounding bar.

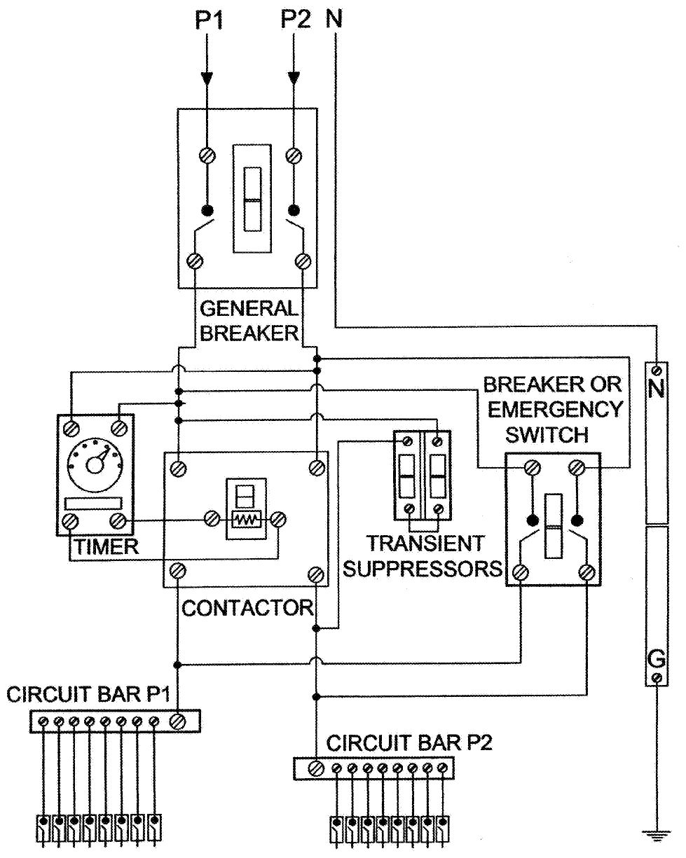

### DETAILED DESCRIPTION

The invention of Total Shielding of electrical installations uses a contraption of sensors and controls for the protection of electrical installations at buildings, against overvoltages or undesired current fluctuations. It detects the presence of undesired voltages or currents before they enter the installation and automatically cuts off the electrical fluid, thereby protecting the entire installation and every device connected to it. After a brief period, when voltages have returned to their acceptable levels, electrical flow is restored and all operations continue to function normally, after shielding the entire installation from any harmful impacts, all without human intervention.

This type of shielding guarantees the flow of reasonable currents to all networks and devices connected to the building's Total Shielding installation. It protects the internal networks from relatively small voltage or current variations, which although relatively safe for most operations, may damage or, at best, result in miscalibration of delicate equipment. On the other hand, it also protects the building and its installation from large overvoltages, which could cause disastrous damage and even destruction of household appliances and other electrical equipment. Such overvoltages could also produce electric arcing and the burning and melting of internal wiring, which could end in the conflagration of the property.

It is well known that in the event of lightning, currents flow with magnitudes close to those occurring in short circuits, even above 3,000 amps. Only about 50% of these currents are eliminated by grounding and the rest wreaks havoc. This risk is eliminated by the Total Shielding system, since for cases of an extreme eventual load, there is a contactor in the current design that does not allow the passage of this type of catastrophic currents. The contactor acts as a potential fuse of great magnitude that in a similar way to the burning of the filament in old conventional fuses, allows its coil to melt and thus prevents the passage of these devastating currents.

The main components of the Total Shielding system are: a timer; a contactor with an internal coil; transient suppressors; a thermo-magnetic switch as a general breaker; an emergency switch or breaker; bars for connecting thermomagnetic switches or breakers; the neutral bar; and the grounding bar.

1. A method for preventing the entry of undesired voltages or currents to residential, commercial, and industrial electrical installations, offering total shielding to networks, breaker boxes, electric equipment, devices, and ultimately an entire building, comprising the steps of:
monitoring and detecting slight surges and large deviations in voltages or currents likely to cause damage to equipment in any part of the building, or catastrophic effects in any or all of the networks, breaker boxes, electrical equipment, devices, and the entire building installation;
cutting off the voltages or currents upon detection of the undesired variations until conditions return to normal; and
restoring safely and automatically the voltages or currents to the electrical installation without the need for human interaction.

2. An apparatus for preventing the entry of undesired voltages or currents to residential, commercial, and industrial electrical installations, offering total shielding to networks, breaker boxes, electric equipment, devices, and ultimately an entire building, comprising:
a monitoring element to monitor and detect slight surges and large deviations in voltages or currents likely to cause damage to equipment in any part of the building, or catastrophic effects in any or all of the networks, breaker boxes, electrical equipment, devices, and the entire building installation;
a suppressing element to cut off the voltages or currents upon detection of the undesired variations until conditions return to normal; and
a restoring element to automatically restore the voltages or currents to the electrical installation without the need for human interaction.

3. The apparatus for preventing the entry of undesired voltages or currents as claimed in claim 2, further comprising:
a system that fully or partially integrates the total shielding functions to a thermomagnetic switch or a circuit breaker box, using current or future technology.

4. The apparatus for preventing the entry of undesired voltages or currents as claimed in claim 2, further comprising:
a stand-alone total shielding box installed in series between an external power supply and the building's circuit breaker box.
